(19) United States
(12) Patent Application Publication
(10) Pub. No.: US 2008/0278307 A1
(43) Pub. Date: Nov. 13, 2008

(54) STRUCTURE OF WARNING LIGHT

(76) Inventor: Yung-Fa LIN, Banqiao City (TW)

Correspondence Address: RABIN & BERDO, P.C.;Suite 500, 1101 14 Street, NW, Washington, DC, 20005, US

(21) Appl. No.: 11/745,619

(22) Filed: May 8, 2007

(51) Int. Cl. B60Q 1/26

(52) U.S. Cl. 340/468

(57) ABSTRACT

A warning light relates to a light device that can be affixed to a vehicle and emits glaring light to give alert, specifically to a warning light, of which the power is converted from solar energy and a vibration sensor module activates a light module to emit light. The light emission is made every second and each of which lasts for one minute so as to give glaring light, which maximizes alert effectiveness.

### BACKGROUND OF THE INVENTION

I. Field of the Invention

The present invention relates to a warning light that can be installed on any vehicle so as to give alert by light, specifically to a warning light that can improve alert effectiveness with glaring light.

II. Description of the Prior Art

With reference to FIG. 1, which shows a reflective film of the prior art, the reflective film 10, which has reflective properties in darkness, is applied for improving safety and nighttime visibility by reflecting headlight beams of other vehicles. Driving at night is more dangerous than daytime driving. Traffic accident rate is greater at night than during the day. Most of the motorists are at risk for problems with nighttime driving as darkness reduces depth perception and reaction times. The reflective film 10 that reflects headlight beams of other vehicles can give better nighttime visibility, and thus improving safety in nighttime driving.

With reference to FIG. 2, which shows a warning light of the prior art, the warning light 20 is adapted to vehicles for giving alert. The warning light 20 mainly consists of a circuit board 201, a light module 202 and an electric wire 203, which is electrically connected to the vehicle's electronic system. The vehicle vibrates while getting start up. The vehicle's vibration will drive the circuit board 201 of the warning light 20 to send out signal to the light module 202 commanding light emission. Instead of electric connection with the vehicle's electronic system, the warning light 20 can have a battery for power supply, which is a better choice for driving safety. Nevertheless, electric connection of the warning light 20 and the vehicle's electronic system increases complexity in manufacturing of electronic system in vehicle. Moreover, the battery requires constant replacement, which may take place in nighttime driving and thus causing higher risks.

### SUMMARY OF THE INVENTION

It is desirable to provide a warning light that avoids foregoing drawbacks. Main objective of the present invention is to provide an innovative warning light that maximizes alert effectiveness with glaring light.

To achieve the foregoing objective, the present invention provides a warning light that consists of a mounting, a receptacle, a circuit board, a solar energy receiver, an accumulator and a covering. The mounting and the covering can tightly close together by fitting the mounting's buttons in the covering's button holes. The circuit board comprises a light module and a vibration sensor module. When the warning light of the present invention is installed on a vehicle, it can absorb solar energy so as to convert into electric power that is saved in the accumulator for use. The vehicle vibrates while being getting start up and thus activates the vibration sensor module to send out signal to the circuit board commanding the accumulator to supply the light module with electric power, which enables the light module to emit light.

Desirable structure, assembly and features of the present invention will be better understood from the detailed description and drawings that follow, in which various embodiments of the disclosed invention are illustrated by way of example.

### BRIEF DESCRIPTION OF THE DRAWINGS

FIG. 1 shows a reflective film of the prior art.

FIG. 2 shows a warning light of the prior art.

FIG. 3 is an entity-relation diagram of the invention.

FIG. 4 is an exploded view of the invention.

FIG. 5 is a cross-sectional view of appearance of the invention.

FIG. 6 shows embodiment (I) of the invention installed on doors of a vehicle.

FIG. 7 shows embodiment (II) of the invention served as a taillight to a bicycle.

FIG. 8 shows embodiment (III) of the invention affixed onto a helmet.

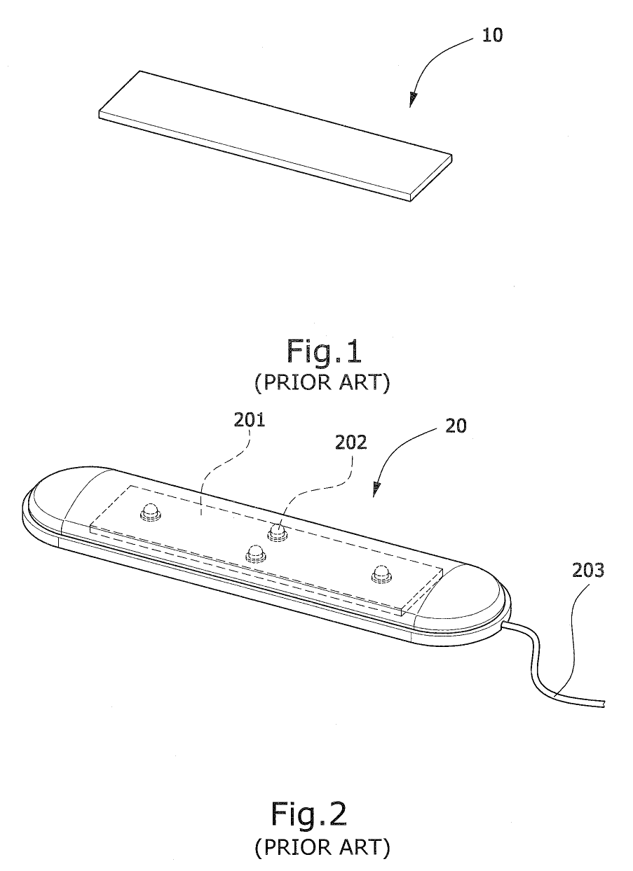

### DESCRIPTION OF THE PREFERRED EMBODIMENTS

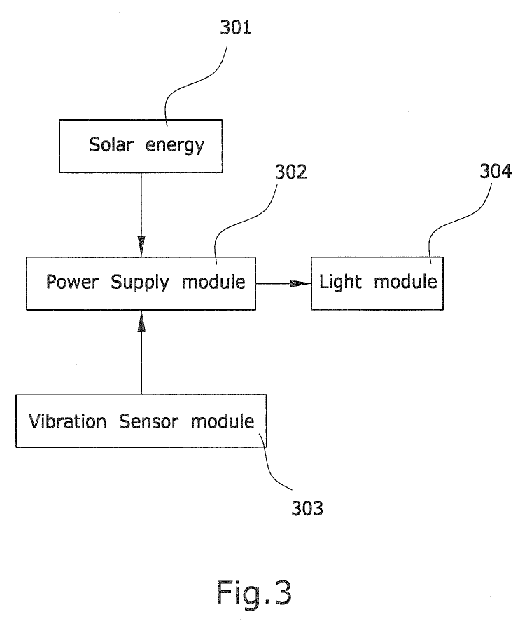

With reference to FIG. 3, which is an entity-relation diagram of the present invention, the present invention consists of a power supply module 302, a vibration sensor module 303 and a light module 304. The power supply module 302, which is a combination of solar energy receiver, accumulator and circuit board, receives and converts the solar energy 30 into electric power for storage. The present invention can be mounted on doors or any part of a vehicle and emit light that makes the part on which it is mounted glistening so as to provide alert. The vehicle vibrates while being getting start up, and thus driving the vibration sensor module 303 to send out signal to the power supply module 302 commanding power supply to the light module 304 for light emission.

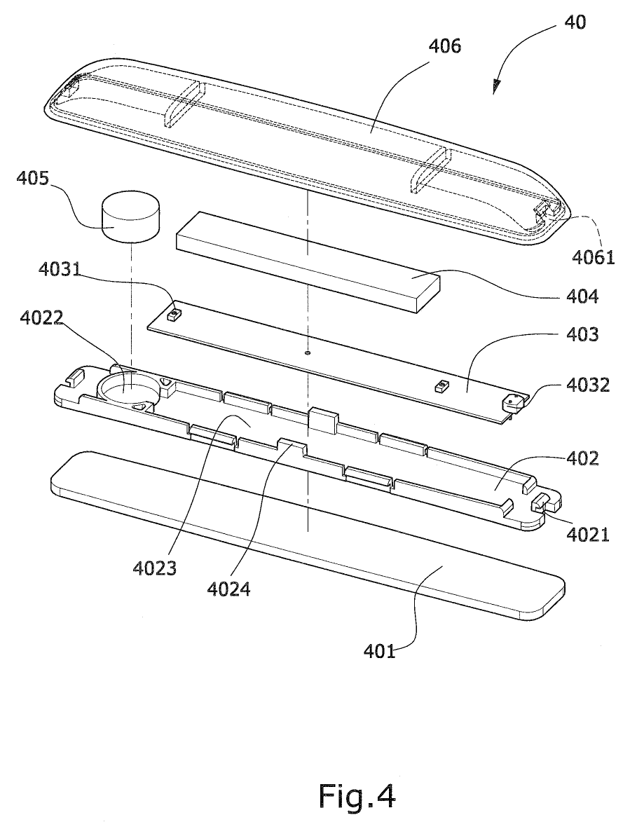

With reference to FIG. 4, which is an exploded view of the present invention, the warning light 40 consists of a mounting 401, a receptacle 402, a circuit board 403, a solar receiver 404, an accumulator 405 and a covering 406. The circuit board 403 comprises a light module 4031 and a vibration sensor module 4032. The receptacle 402, which can be bonded or buckled onto a mounting 401, comprises a hole 4022, an opening 4023, two pins 4024 and a plurality of buttons 4021. The hole 4022 is for ensconcing a battery 405. The opening 4023 is for inlaying a circuit board 403. The pins 4024, which protrudes from lengthwise sides, can affix the circuit board 403 in position. The buttons 4021, which are formed on outer edge of the receptacle 402 are correspond to button holes 4061 the covering 406 and can snugly fit therein. The covering comprises a plurality of button holes 4061, which is formed in corresponding positions with the buttons 4021 formed around outer edge of the receptacle 402. Assembly of the warning light 40 is made per following steps: bond or buckle the receptacle 402 onto a mounting 401; ensconce the accumulator 405 in the hole 4022 on the receptacle 402; mount the solar energy receiver 404 onto the circuit board 403, inlay said circuit board 403 in the opening 4023 of the receptacle 402 and fasten it in position by pins 4024; close together the covering 406 and the receptacle 402 by fitting the receptacle's buttons 4021 into the covering's button holes 4061.

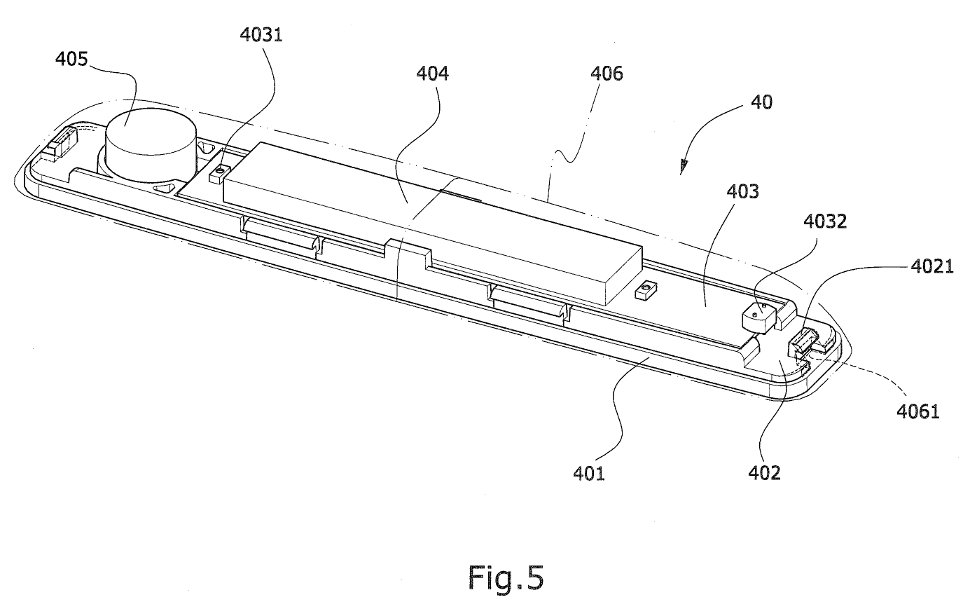

With reference to FIG. 5, which is a cross-sectional view of appearance of the present invention, the receptacle 402, which is bonded or buckled onto a mounting 401, is sealed with a covering 406 so as to provide perfect protection to the parts fit therein. The covering 406 and the receptacle 402, which is bonded or bucked onto a mounting 401, can be tightly closed together by two ways: directly bond said covering 406 onto said mounting 401, or buckle said receptacle 402 in said covering 406 by fitting said receptacle's buttons 4021 into said covering's button holes 4061. The warning light 40 of the present invention, which can convert the solar energy into electric power for storage, needs neither a battery holder to hold battery nor an electric wire for electric connection with the vehicle's electronic system. Structure of the present invention is very simple so as to result in retrenched manufacturing process and maximized easiness in installation. It is clear that the present invention possesses the advantages of maximizing cost effectiveness, production efficiency and user's friendliness. When the vibration sensor module 4032 senses vibration of the object on which the warning light is mounted, it sends out the signal to the circuit board 403 commanding the accumulator 405 to supply electric power to the light module 4031 so that the light module 4031 can emit light. The light emission is made every second and each of which lasts for one minute so as to achieve effective alert with glaring light. The mounting 401 has one side to support the receptacle and the other side to affix onto surface of a vehicle, on which may be adhered with a double-sided tape or fitted with a plurality of anchoring pins. Moreover, the light module 4031 is a LED module, which comprises LED chips of different colors so as to maximize the color combination.

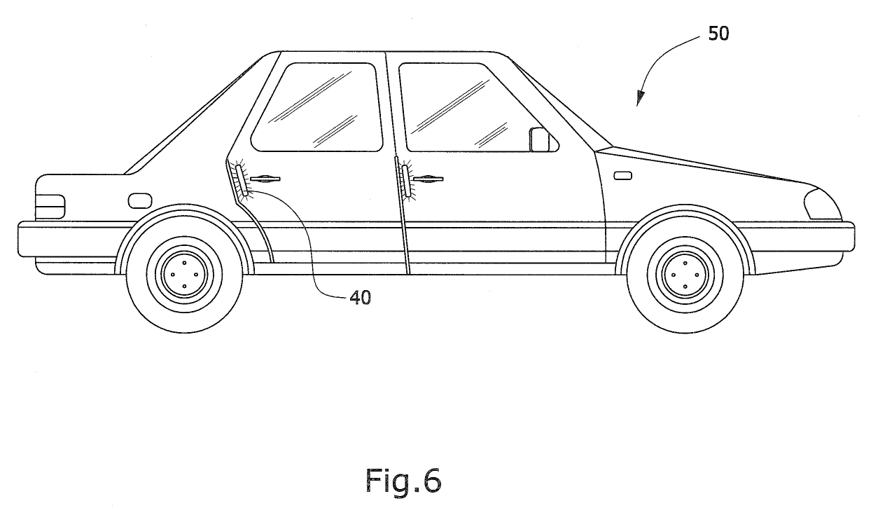

With reference to FIG. 6, which shows embodiment (I) of the present invention installed on doors of a vehicle, the warning light 40 absorbs the solar energy during the day and converts it into electric power for storage so as to be used in empowering the light emission in night. The vehicle 50, doors of which are installed with warning lights 40, would have less risk in fender-bender and accidents because the warning light 40 can make the vehicle more visible in night by emitting light, which makes the doors glistening in night. Furthermore, when said vehicle 50 is running in main line, its glistening doors give prior alert to motorists who are about to enter into main line from branch lines, and thus avoiding accidents.

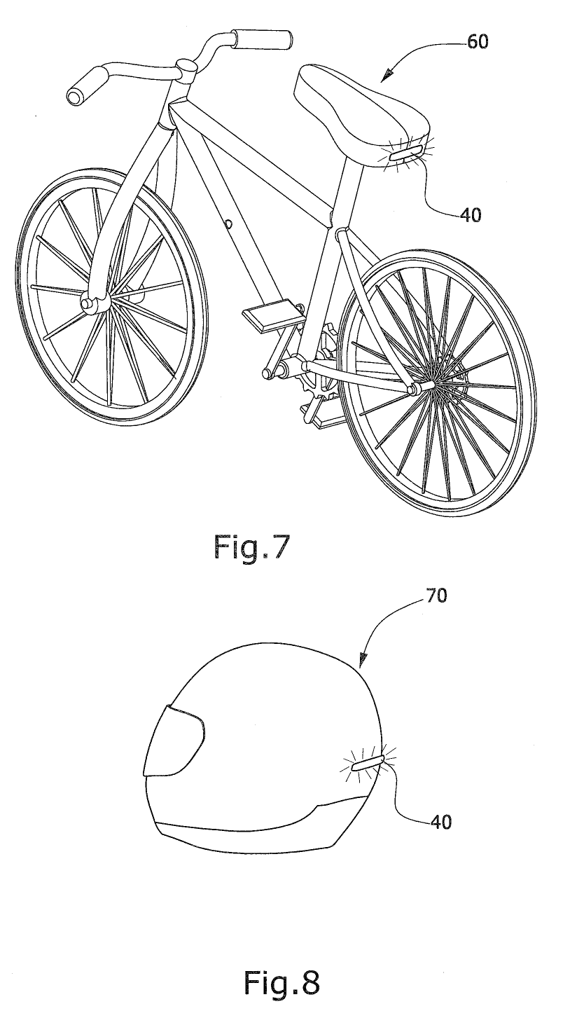

With referenced to FIG. 7, which shows embodiment (II) of the present invention served as a taillight to a bicycle, the warning light 40 is affixed to bicycle saddle. The bicycle 40, which is a pedal-driven and human powered vehicle, is less speedy than any motor-driven vehicle and has been adapted for use in many human activities though. However, riding bicycle is more dangerous than driving vehicle as the bicyclist unlike the motorist is exposed to open air. It is thus critical for bicyclists to put on safety protection. The warning light 40 can be affixed to bicycle saddle so as to make the bicyclist more visible to motorists, and thus avoid accidents. In lieu of saddle, the warning light 40 can also be affixed on top tube and headsets of a bicycle 60 so as to make the bicyclist more visible in every direction.

With reference to FIG. 8, which shows embodiment (III) of the present invention affixed onto a helmet, the warning light 40 can make the helmet glistening so as to improve motorcyclists' safety and nighttime visibility. Most of the motorists are at risk for problems with nighttime driving as darkness reduces depth perception and reaction times. Extra protection that improves motorcyclists' nighttime visibility can prevent them from being hit by vehicle. Among others, a glistening helmet would be the best choice. The warning light 40 of the present invention can be affixed to any helmet 70 and turn it into a glistening one so as to improve the motorcyclist's safety and nighttime visibility. To sum up, the warning light 40 of the present invention that uses power converted from solar energy instead of electric power supplied by battery or electric connection with vehicle's electronic system provides easiness in installation and convenience in use. It absorbs and converts the solar energy into electric power for storage, and activates the light emission by vehicle's vibration. Light emission takes place every second and each of which lasts for one minute so as to emit glaring light, which maximizes the alert effectiveness. It can be adapted to vehicle 50, bicycle 60 or helmet 70 so as to give alert. The foregoing embodiments prove that the present invention can be adapted to vehicle, bicycle and helmet, and substantially maximizes alert effectiveness with glaring light.

While the present invention is susceptible to various modifications and alternative forms, specific embodiments have been shown by way of example in the drawings and described in detail herein. However, it should be understood that the invention is not intended to be limited to the particular form disclosed. Rather, the invention is to cover all modifications, equivalents, and alternatives falling within the spirit and scope of the invention as defined by the appended claims.

What is claimed is:

1. A warning light, which uses solar energy to emit light for giving alert, comprises:
a mounting;
a receptacle, which fits on said mounting and comprises a hole, an opening, a plurality of pins formed on lengthwise sides and buttons formed on outer edge: said hole for ensconcing a battery; said opening for inlaying a circuit board, on which a light module and a vibration sensor module are installed;
a solar energy receiver, which is mounted on the circuit board, near to the light module; and
a covering, which comprises a plurality of button holes in which the receptacle's buttons can fit so as to make the covering and the receptacle close together.

2. The warning light of claim 1, wherein a double-sided tape may adhere to one side of the mounting.

3. The warning light of claim 1, wherein anchoring pins may be installed on the other side of the mounting.

4. The warning light of claim 1, wherein the light module is a LED module.
